(19) United States
(12) Patent Application Publication
(10) Pub. No.: US 2010/0192164 A1
(43) Pub. Date: Jul. 29, 2010

(54) METHOD FOR THE TRANSPARENT REPLICATION OF A SOFTWARE COMPONENT OF A SOFTWARE SYSTEM

(76) Inventors: Michael Golm, Princeton, NJ (US); Klaus Jürgen Schmitt, Neuried (DE); Konrad Schwarz, Neubiberg (DE)

Correspondence Address: HARNESS, DICKEY & PIERCE, P.L.C., P.O.BOX 8910, RESTON, VA, 20195, US

(21) Appl. No.: 12/669,823

(22) PCT Filed: Jun. 5, 2008
(86) PCT No.: PCT/EP08/56960

§ 371 Date: Jan. 20, 2010

(30) Foreign Application Priority Data
Jul. 20, 2007 (DE) 10 2007 033 885.8

(51) Int. Cl. G06F 9/52; G06F 9/46

(52) U.S. Cl. 719/319

(57) ABSTRACT

In a method for the transparent replication of a software component (SWC1) of a software system (SWC1, SWC2), in particular according to the AUTOSAR standard, in a computation system with two or more processing units (VEA, VEB), the processing units (VEA, VEB) are connected to one another, by one or more communication channels (KK1, KK2), for the purpose of interchanging data. Each of the processing units (VEA, VEB) has a runtime environment (RTE) in which respective runtime environments (RTE) of the processing units (VEA, VEB), which are to be replicated, are provided with a synchronization and selection functionality (Sync, Voting).

### CROSS-REFERENCE TO RELATED APPLICATIONS

This application is a U.S. National Stage Application of International Application No. PCT/EP2008/056960 filed Jun. 5, 2008, which designates the United States of America, and claims priority to German Application No. 10 2007 033 885.8 filed Jul. 20, 2007, the contents of which are hereby incorporated by reference in their entirety.

### TECHNICAL FIELD

The invention relates to a method for the transparent replication of a software component of a software system, particularly as defined in the AUTOSAR standard, in a computer system comprising two or more processing units, said processing units being interconnected via one or more communication channels for the exchange of data.

### BACKGROUND

AUTOSAR is an automotive industry standard in which interfaces and interactions of software components are specified in the form of XML descriptions (XML=Extendable Markup Language). AUTOSAR allows architecture-centric modeling of complex software systems. This means that code for transmitting data is generated, while a functionality (algorithms) is manually implemented or generated by computer-aided tools. For all the inputs and outputs, I/O (input/output) functions known as RTE calls are provided. Building blocks for modeling functionalities are termed components and compositions. Compositions comprise a plurality of components which are interconnected via communication links. Components and compositions are interconnected via so called ports. Ports constitute communications interfaces in order to exchange data between individual components and to enable function calls between the components. Depending on the design of the computer system, the software components in safety-critical applications must be adapted to the particular hardware architecture. Alternatively, special hardware can be used for transparent replication.

### SUMMARY

According to various embodiments, a method for the transparent replication of a software component of a software system, in particular as defined by the AUTOSAR standard, can be specified which allows the unmodified use of AUTOSAR software components in safety-critical applications requiring in particular a multi-channel data processing system.

According to an embodiment, in a method for the transparent replication of a software component of a software system, in particular as defined by the AUTOSAR standard, in a data processing system comprising two or more processing units, the processing units are interconnected via one or more communication channels for the exchange of data, and each of the processing units comprises a runtime environment in which runtime environments to be replicated for the processing units are provided with a synchronization and voting functionality.

According to a further embodiment, a virtual communication channel can be provided between the replicated runtime environments. According to a further embodiment, to implement a functionality of the software component a number of components can be interconnected virtually, irrespective of the assignment of the components to the runtime environments to be replicated. According to a further embodiment, the components of a functionality can be interconnected for exchanging data across communications interfaces comprising send and receive ports, data being fed to the receive ports on an event-driven basis or by polling. According to a further embodiment, reception of data at one of the receive ports may trigger the initiation of code sequences which are executed on the redundant processing units. According to a further embodiment, the code sequences can use a runtime environment code for communicating with other components or for invoking services. According to a further embodiment, the code sequences may use the runtime environment or environments as middleware in order to exchange data with other components or to make remote procedure calls. According to a further embodiment, the components can be duplicated on redundant processing units and the signal processing steps are synchronized by the runtime environments of the redundant processing units. According to a further embodiment, runtime environment calls can be performed synchronously. According to a further embodiment, synchronization may take place via the communication channel between the runtime environments to be replicated. According to a further embodiment, all the signals can be fed to input ports of compositions, comprising a plurality of communicatively interconnected components, and simultaneously to the input ports of the redundant compositions. According to a further embodiment, prior to the outputting of a signal all the output ports can be compared with the result of the redundant component and combined into a common result. According to a further embodiment, at the time of runtime environment generation it may be determined which of the processing units has been assigned which components and which of the processing units has been assigned the associated redundant components, from which information the runtime environments determine physical synchronization paths for all the synchronization points and generate corresponding runtime environment code.

### BRIEF DESCRIPTION OF THE DRAWINGS

The invention will now be explained in greater detail with reference to the accompanying drawings in which:

FIG. 1 is a schematic of a data processing system comprising a plurality of processing units, illustrating the transparent replication of a software component of a software system,

FIG. 2 schematically illustrates the virtual interconnection of components of a software component,

FIG. 3 schematically illustrates a software functionality in the form of a sequence of code sequence calls,

FIG. 4 schematically illustrates duplicated code sequences, and

FIG. 5 is a schematic which illustrates the mapping of software components to different processing units.

### DETAILED DESCRIPTION

In the method according to various embodiments for the transparent replication of a software component of a software system in a data processing system comprising two or more processing units, the processing units are interconnected via one or more communication channels for exchanging data. Each of the processing units comprises a runtime environment. Particular processing unit runtime environments to be replicated are provided with a synchronization and voting functionality.

The method according to various embodiments allows precise synchronization of applications between parallel runtime environments, said method requiring no time synchronization.

The method according to various embodiments uses an extension of the runtime environments RTE. The AUTOSAR runtime environment is a tool-generated middleware which permits, among other things, locally transparent communication between software components. In order to provide replication transparency, the runtime environment is extended to include a synchronization and voting functionality, a virtual communication channel being created between the replicated runtime environments. Communication between different software components can take place in different ways: In the case of a sender/receiver system it can be “queued” or “unqueued”. In the case of a client/server system it can be synchronous or asynchronous. Communication within a software component can take place using so-called “interrunnable variables” or “exclusive areas”. Communication with services of the processing unit (so-called ECU=Electronic Control Unit) can be implemented as “communication with services” or as “communication with IO abstraction”. The internal behavior of the software components includes the following possibilities: “invocation of runnable entities”, blocking and unblocking of runnables at “wait points”, “reception of RTE events”, “per-instance memory” and “initialization/finalization”. A precise description of communication via the virtual communication channel can be found in the document “Specification of the AUTOSAR Runtime Environment, Version 2.0.0” of the Autosar partnership.

To implement a functionality of the software component, a number of components are interconnected virtually, independently of the assignment of the components to the runtime environments to be replicated.

The components of a functionality are interconnected for exchanging data across communications interfaces comprising send and receive ports, data being fed to the receive ports in an event-driven manner or by polling.

The reception of data triggers at one of the receive ports the initiation of code sequences which are executed on the redundant processing units. The code sequences can use a runtime environment code for communicating with other components or for invoking services. This means that a software functionality can be represented by a sequence of code sequence calls. Code sequences are also known as runnable entities. Code sequences use the runtime environment as middleware in order to exchange data from other components or to make what are known as remote procedure calls.

According to another embodiment, the components are duplicated on redundant processing units. The signal processing steps are synchronized by the runtime environments of the redundant processing units. The transparent runtime environment concept therefore consists in redundancy being ensured by the runtime environment itself.

Synchronization takes place via the communication channel between the runtime environments to be replicated.

Synchronization can be carried out via the bus or a so-called dual-port RAM. This is also termed the synchronization channel.

According to another embodiment, all the signals present at the input ports of compositions are simultaneously fed to the input ports of the redundant compositions, each of the components comprising a plurality of communicatively interconnected components.

In another embodiment, all the output ports are compared with the result of the redundant component prior to the outputting of a signal and combined into a common event. This describes the output functionality in the runtime environment, which is also known as voting. For each output port subject to voting, it must be clearly established which action or actions must be carried out in the case of success and in the case of failure. In the event of success, both sub-results of the redundant component coincide, e.g. within defined tolerances. In the event of failure, the sub-results determined by the redundant components are different. Port accesses or other I/O functions which are not brought out must be time-synchronized, without carrying out voting.

At the time of runtime environment generation it is determined which of the processing units has been assigned which components and which of the processing units has been assigned the associated redundant components, from which information the runtime environments generate physical synchronization paths for all the synchronization points and generate corresponding runtime environment code. The term physical synchronization path denotes the connection between a processing unit and its redundant partner processing unit. This can be a point-to-point connection or a bus, such as e.g. a CAN bus, FlexRay bus, etc.

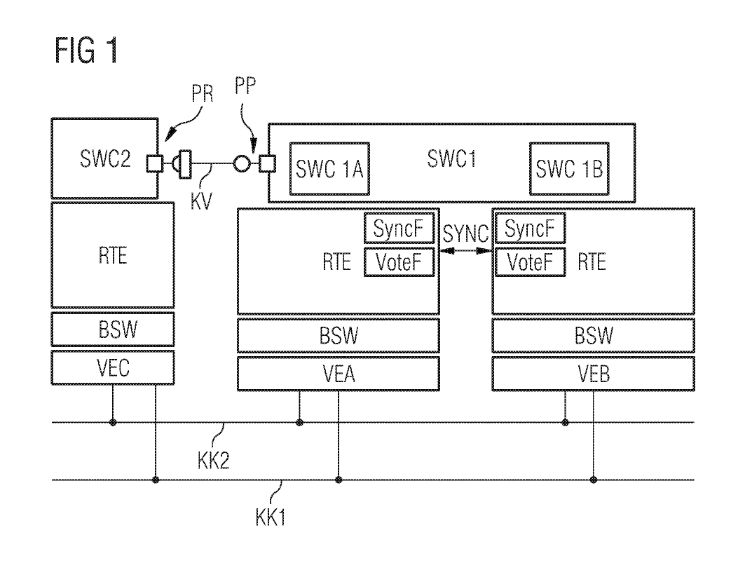

FIG. 1 schematically illustrates a data processing system comprising processing units VEA, VEB and VEC. The processing units VEA, VEB, VEC are interconnected via two communication channels KK1, KK2 for the exchange of data. The communication channels KK1, KK2 can be constituted, for example, by a bus (e.g. CAN bus or FlexRay bus). The processing units VEA, VEB, VEC can be control devices, for example, and are generally so-called ECUs (Electronic Control Units). Each of the processing units comprises in known manner a base software functionality BSW. This comprises, for example, an operating system, means of communication via the communication channels, drivers for communication or memory access. Each of the processing units additionally comprises a runtime environment RTE.

The processing units VEA, VEB are assigned a software component SWC1. The software component SWC1 comprises two instances SWC1_{A} and SWC1_{B}, the former being assigned to the processing unit VEA and the latter to the processing unit VEB. The instances SWC1a, SWC1b of the software component SWC constitute redundant functionalities which are executed on the runtime environments RTE of the processing units VEA and VEB.

The processing unit VEC is assigned a software component SWC2. The software component SWC2 is connected to the software component SWC1 via a communication connection KV. For this purpose the software component SWC2 has a port PR which is designated the required port. Similarly, the software component SWC1 has a port PP designated the provided port. In the schematic drawing, communication connection KV does not represent a physical connection, but merely a virtual connection for representing the functionalities. Data is actually exchanged via one of the communication channels KK1 or KK2.

The runtime environments RTE of the processing units VEA and VEB are extended compared to a standard AUTOSAR runtime environment. The AUTOSAR runtime environment is generally a tool-generated middleware which permits, among other things, locally transparent communication between software components. To implement additional replication transparency, the runtime environments RTE of the processing units VEA and VEB are extended to include synchronization and voting functionality (SyncF, VoteF). Also marked between the runtime environments RTE of the processing units VEA and VEB is a virtual communication channel SYNC which is termed a synchronization path. The communication channel is a prerequisite for implementing replication transparency. To implement replication transparency, the following characteristics of the runtime environment must be extended accordingly: Communication between different software components. Communication within a software component. Communication with services of the processing unit and the internal behavior of the software component.

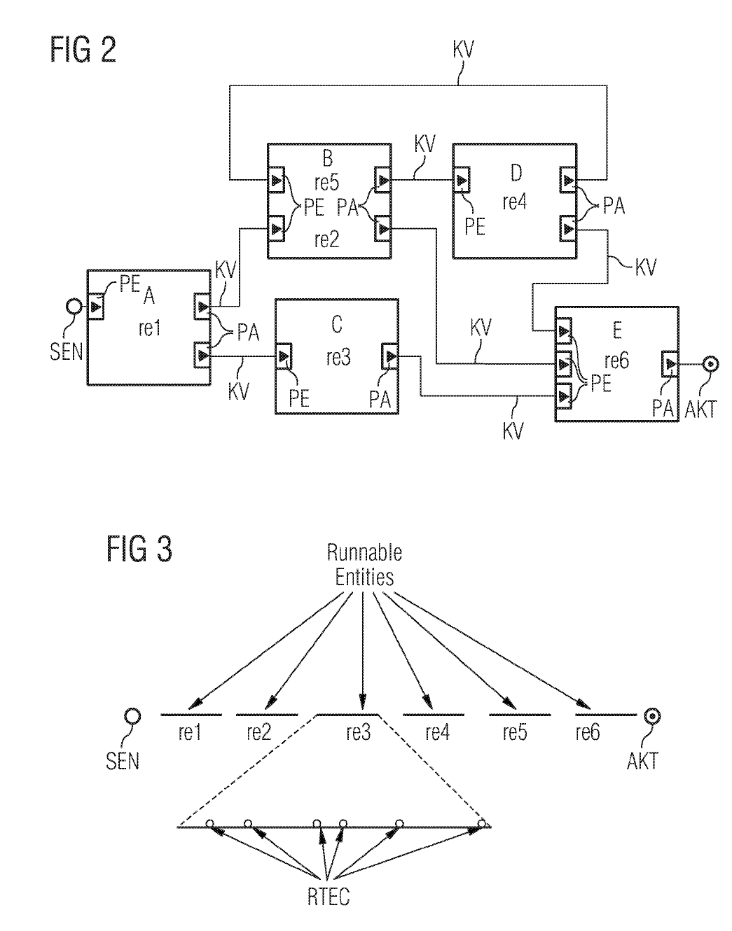

Modeling of replication transparency will now be described with reference to FIGS. 2 to 5. The modeling begins with virtual interconnection of the components. This is shown by way of example in FIG. 2. In this virtual view, connections KV can be made between components. Communication connections can be made irrespective of how the components are assigned to the runtime platform. The functionality illustrated in FIG. 2 consists of five components A to E which are interconnected via ports PE, PA. Said ports PE, PA constitute the interfaces for exchanging data. There are transmit ports PA and receive ports PE.

At receive ports PE, data can be fed to the components on an event-driven basis or by polling of the further processing. In each case the reception of data causes a so-called runnable entity re1, re2, re3, re4, re5, re6 to be initiated, in the context of which processing of the data takes place. Runnable entities are code sequences which can be executed on one or different processing units. The latter use the runtime environment as middleware in order to exchange data from other components or to make so-called RPC (Remote Procedure calls). Denoted by SEN in FIG. 2 is a sensor which is connected to a receive port PE of component A via a communication connection. An actuator AKT is connected to a send port PA of the component E via a communication connection. The respective communication connections KV which connect a transmit port PA to an output port PE are created according to a desired functionality.

RTE calls RTEC offer the only possibility of exchanging data with other components or services. The implementation of the code sequences via runnable entities consists of manually implementable code which can use the generated runtime environment code for communication with other components or for invoking services. This means that a software functionality can be represented by a sequence of runnable entity calls (re1-re2-re3-re4-re5-re6). This is shown in FIG. 3. The transparent runtime environment concept consists in redundancy being ensured by the runtime environment RTE. This takes place by duplication of the components on redundant processing units and the synchronization of the signal processing steps by the runtime environment. The effect of this is that the RTE calls can be made synchronously. In addition, time-synchronous input/output (I/O) operations can be carried out. Synchronization is performed by a high-performance bus or shared i.e. dual-port memory, hereinafter also referred to as the synchronization channel. Duplication of the components on redundant processing units is illustrated in FIG. 1 by the instances SWC1_{A} and SWC1_{B}.

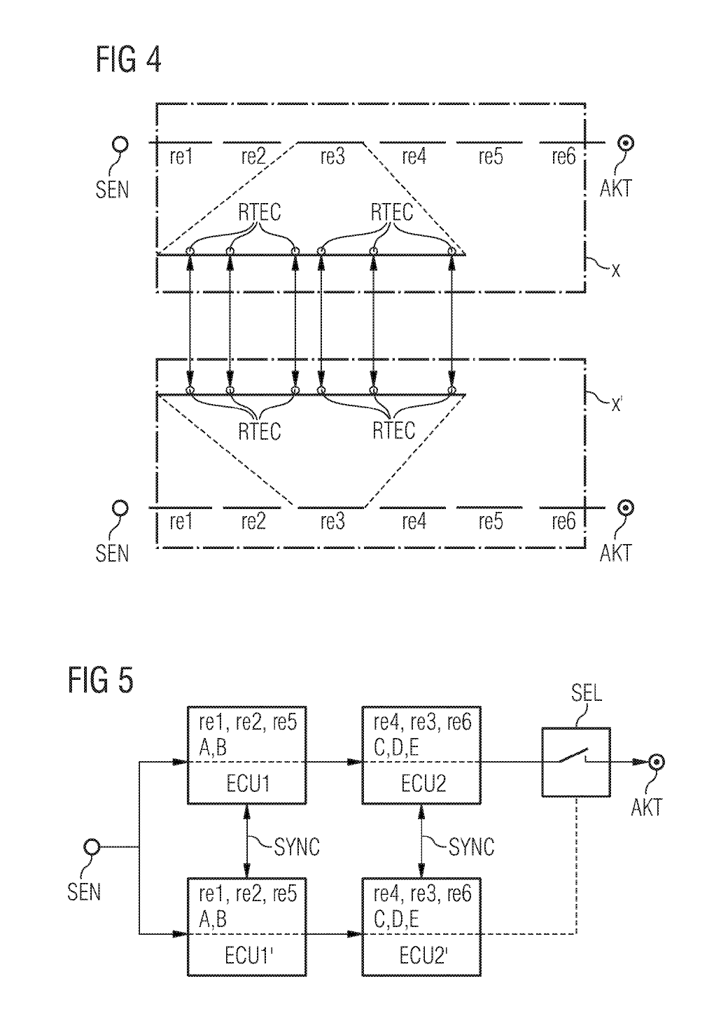

FIG. 4 shows a schematic representation from the point of view of a runnable entity with duplicated runnable entities re1 to re6. A system X (instance of a software component) has been duplicated by the system X′. The system X′ carries out all the processing steps like the system X. The systems X and X′ are synchronized for each RTE call RTEC. This is shown by the arrows running between the RTE calls.

The transparent replication of AUTOSAR software components allows any number of software components (composition) to be executed redundantly. A composition has input and output ports which are brought out. In AUTOSAR these are termed “delegation ports”. Ports which are interconnected internally are known as “assembly ports” in AUTOSAR. Delegation ports represent the behavior with respect to the outside world and must be particularly taken into account for redundancy considerations. All the signals and input ports, the so-called “required ports”, must be fed simultaneously to the input ports of the redundant components. Prior to the outputting of a signal, all the output ports, the “provided ports”, must be compared with the result of the partner component and combined to form a common result. This process is termed selection functionality or voting. For each output port subject to voting it must be clearly established which action or actions must be carried out in the case of success and in the case of failure. In the event of success, both sub-results, i.e. results which have been determined by the systems X and X′, coincide within defined tolerances. In the event of failure, the sub-results determined by the systems X and X′ are different. Port accesses or other RTE calls which are not brought out must be time-synchronized, without executing voting or a selection functionality.

Synchronization will be explained in detail with reference to FIG. 5. The AUTOSAR method permits static mapping, i.e. mapping at the time of configuration of software components on the processing units. As the mapping is static, it is known at the time of runtime environment generation which components have been mapped to which processing units. This permits the generator of the runtime environment to find physical synchronization paths for all the synchronization points and generate the corresponding code. A physical synchronization path is taken to mean the connection between an ECU instance and its redundant partner processing unit. This can be a point-to-point connection and also a bus.

FIG. 5 shows the physical view, after mapping has been performed, for the virtual view shown at the beginning (FIG. 2). In FIG. 5 the instances of the software component are labeled ECU1 and ECU2. Redundant instances of the software component are labeled ECU1′ and ECU2′. In the example in FIG. 5, the components A and B have been mapped to the ECU instance ECU1, while the components C, D and E have been mapped to the ECU instance ECU2. Each of the ECU instances ECU1, ECU2 has a redundant double ECU1′, ECU2′ on which the components are likewise mapped. The ECU instances each have a synchronization channel SYNC to their redundant partners. In the configuration shown, the runtime environment can undertake synchronization for the transparent replication of AUTOSAR software components. This means that the functionality for synchronization of the replicated AUTOSAR software components can be generated transparently without explicit modeling for the application. FIG. 5 also shows a selector switch SEL which is connected to the output of the ECU instance ECU2. It is also connected to the actuator AKT. The switch position is defined by the output signal of the redundant ECU instance 2 ECU2′. In the event that the sub-results determined by the ECU instances ECU2 and ECU2′ are identical, the switch is closed so that the output signal can be forwarded to the actuator AKT.

Replication can take place, for example, on symmetric microcontrollers which are interconnected by a direct communication channel with low latency times (e.g. dual-ported RAM). Replication can also take place on diversity microcontrollers which are interconnected by a direct communication channel with direct latency times (e.g. dual-ported RAM). Replication is possible in a network of control devices connected by CAN bus or FlexRay bus. Replication is also possible on a microcontroller, replicated code being executed in a time-offset manner.

What is claimed is:

1. A method for the transparent replication of a software component of a software system in a data processing system with two or more processing units, the method comprising the steps of:
interconnecting the processing units via one or more communication channels for the exchange of data, and
providing each of the processing units with a runtime environment in which runtime environments to be replicated for the processing units are provided with a synchronization and voting functionality.

2. The method according to claim 1, comprising the step of providing a virtual communication channel between the replicated runtime environments.

3. The method according to claim 1, wherein to implement a functionality of the software component a number of components are interconnected virtually, irrespective of the assignment of the components to the runtime environments to be replicated.

4. The method according to claim 3, wherein the components of a functionality are interconnected for exchanging data across communications interfaces comprising send and receive ports, data being fed to the receive ports on an event-driven basis or by polling.

5. The method according to claim 4, wherein reception of data at one of the receive ports triggers the initiation of code sequences which are executed on the redundant processing units.

6. The method according to claim 5, wherein the code sequences can use a runtime environment code for communicating with other components or for invoking services.

7. The method according to claim 5, wherein the code sequences use the runtime environment or environments as middleware in order to exchange data with other components or to make remote procedure calls.

8. The method according to claim 1, wherein the components are duplicated on redundant processing units and the signal processing steps are synchronized by the runtime environments of the redundant processing units.

9. The method according to claim 8, wherein runtime environment calls are performed synchronously.

10. The method according to claim 9, wherein synchronization takes place via the communication channel between the runtime environments to be replicated.

11. The method according to claim 1, wherein all the signals are fed to input ports of compositions, comprising a plurality of communicatively interconnected components, and simultaneously to the input ports of the redundant compositions.

12. The method according to claim 1, wherein prior to the outputting of a signal all the output ports are compared with the result of the redundant component and combined into a common result.

13. The method according to claim 1, wherein at the time of runtime environment generation it is determined which of the processing units has been assigned which components and which of the processing units has been assigned the associated redundant components, from which information the runtime environments determine physical synchronization paths for all the synchronization points and generate corresponding runtime environment code.

14. The method according to claim 1, wherein the replication is defined by the AUTOSAR standard.

15. A system for the transparent replication of a software component of a software system according to the AUTOSAR standard, in a data processing system comprising two or more processing units, wherein the processing units are interconnected via one or more communication channels for the exchange of data, and each of the processing units comprises a runtime environment in which runtime environments to be replicated for the processing units are provided with a synchronization and voting functionality.

16. The system according to claim 15, wherein a virtual communication channel is provided between the replicated runtime environments.

17. The system according to claim 15, wherein to implement a functionality of the software component a number of components are interconnected virtually, irrespective of the assignment of the components to the runtime environments to be replicated.

18. The system according to claim 17, wherein the components of a functionality are interconnected for exchanging data across communications interfaces comprising send and receive ports, data being fed to the receive ports on an event-driven basis or by polling.

19. The system according to claim 18, wherein reception of data at one of the receive ports triggers the initiation of code sequences which are executed on the redundant processing units.

20. The system according to claim 19, wherein the code sequences can use a runtime environment code for communicating with other components or for invoking services.
